(19) United States
(12) Patent Application Publication
(10) Pub. No.: US 2022/0075930 A1
(43) Pub. Date: Mar. 10, 2022

(54) DOCUMENT SEARCH SYSTEM AND DOCUMENT SEARCH METHOD

(71) Applicant: Konica Minolta, Inc., Tokyo (JP)

(72) Inventor: Kazuhiro Ishiguro, Toyohashi-shi (JP)

(73) Assignee: Konica Minolta, Inc., Tokyo (JP)

(21) Appl. No.: 17/400,837

(22) Filed: Aug. 12, 2021

(30) Foreign Application Priority Data
Sep. 9, 2020 (JP) 2020-151219

(51) Int. Cl. G06F 40/166; G06F 16/31; G06F 16/583; G06K 9/00

(52) U.S. Cl. CPC G06F 40/166; G06K 9/00456; G06F 16/583; G06F 16/31

(57) ABSTRACT

A document search system includes: a hardware processor that: stores a plurality of pieces of data; extracts first data including an image object from among the plurality of pieces of data, the image object representing text or a graph; specifies, from among the plurality of pieces of data, one or more pieces of second data including an object having a degree of similarity equal to or larger than a threshold with respect to the image object; and associates the image object included in the first data with the one or more pieces of second data.

### CROSS-REFERENCE TO RELATED APPLICATIONS

The entire disclosure of Japanese patent Application No. 2020-151219, filed on Sep. 9, 2020, is incorporated herein by reference.

### BACKGROUND

### Technical Field

The present disclosure relates to a document search system, a document search method, and a non-transitory recording medium storing instructions.

### Description of the Related Art

In recent years, in a search system for search of data, a search system that further displays an image on the basis of an image displayed as a search result has been considered. In a search system of JP 2004-157623 A, a medical image of CT or the like is displayed as a search result in response to a search instruction from a user.

In the search system, language information is assigned to each of medical images, and related medical images are associated on the basis of the language information. As a result, in the search system of JP 2004-157623 A, it is possible to display a related image together with the medical image displayed as the search result, and to display a related case that the user having given the search instruction has not been aware of.

However, in a case where the search system of JP 2004-157623 A is applied to a document search system for search of document data, data may also be displayed that is not important for the user even though the data is related to an image of a search result.

That is, in the document data, a plurality of various images may be included in one piece of document data. Therefore, when data is associated with each of all images included in the document data, a large number of pieces of data that are not important for a user who intends to edit the document data as a search result may be displayed, and efficiency of document editing work may be deteriorated.

### SUMMARY

The present disclosure has been devised in view of the above circumstances, and in a document search system for search of document data including an image and for association of the image with other document data, one or more embodiments provide a document search system, a document search method, and a non-transitory recording medium storing instructions that inhibit deterioration in efficiency of document editing work even when document editing work is performed after search.

According to one or more embodiments of the present invention, a document search system comprises: a hardware processor that: stores a plurality of pieces of data; extracts first data including an image object from among the plurality of pieces of data, the image object representing text or a graph; specifies one or more pieces of second data including an object similar to (i.e., with a degree of similarity equal to or larger than a threshold with respect to) the image object from among the plurality of pieces of data; and associates the image object included in the first data with the one or more pieces of second data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating an overall configuration of a document search system;

FIG. 2 is a view for explaining an image object and document data to be associated with each other;

FIG. 3 is a block diagram illustrating functions of the document search system;

FIG. 4 is a diagram illustrating an internal configuration of a search server;

FIG. 5 is a flowchart illustrating a processing procedure in a search terminal;

FIG. 6 is a flowchart illustrating an association processing procedure of the search server;

FIG. 7 is Display example 1 of a search result displayed by the search terminal;

FIG. 8 is Display example 2 of a search result displayed by the search terminal;

FIG. 9 is Display example 3-1 of a search result displayed by the search terminal;

FIG. 10 is Display example 3-2 of a search result displayed by the search terminal;

FIG. 11 is Display example 4 of a search result displayed by the search terminal;

FIG. 12 is a flowchart illustrating a procedure of specification processing;

FIG. 13 is a view illustrating an example of displaying an image object in an emphasized manner; and

FIG. 14 is a view illustrating generation of editable data corresponding to a content represented by an image object.

### DETAILED DESCRIPTION OF EMBODIMENTS

Hereinafter, embodiments of the present invention will be described with reference to the drawings. However, the scope of the invention is not limited to the disclosed embodiments. In the following description, the same reference numerals are given to the same parts. Their names and functions are also the same. Therefore, detailed description thereof will not be repeated.

<Overall Configuration of Document Search System>

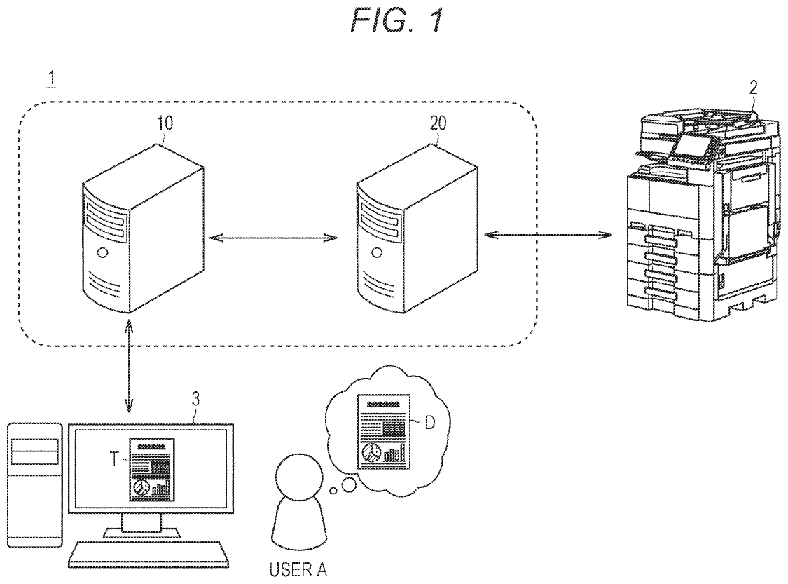

FIG. 1 is a view illustrating an overall configuration of a document search system 1. The document search system 1 according to one or more embodiments includes: a document server 20 that stores a plurality of pieces of document data; and a search server 10 that performs search processing in response to a search instruction from a user.

The document data is typically data created by software such as Word and Excel (registered trademark). The document data may be document data created by other software other than Word and Excel.

The search server 10 is a server for search of document data targeted by a user from among a plurality of pieces of document data stored in the document server 20. The document server 20 is a server for storage of a plurality of documents as document data. The document server 20 may also store image data and the like, in addition to document data. The image data may be used by the user at a time of creating or editing document data.

In one or more embodiments, each of the search server 10 and the document server 20 may be a general-purpose server also having functions other than a function of storing document data. Further, in one or more embodiments, each of the search server 10 and the document server 20 may include a plurality of servers instead of one server. Further, in one or more embodiments, the search server 10 and the document server 20 may be configured as an integrated device, that is, an integrated server.

As illustrated in FIG. 1, the search server 10 and the document server 20 are communicable via a network.

Further, the document server 20 may be connected to a document reading device 2 including a scanner and the like via a network. The document server 20 receives a document read by the document reading device 2 as document data, and stores the document data. The document data stored in the document server 20 is not limited to the document data received from the document reading device 2, and may be, for example, document data received from a terminal (not illustrated).

As illustrated in FIG. 1, the search server 10 is connected to a search terminal 3 used by a user A, via a network. The search terminal 3 includes a display 3d for display of a search result to the user A. The search terminal 3 may be a general-purpose computer, or may be a portable terminal such as a smartphone.

Hereinafter, a flow of search processing of the document search system 1 will be described. The search terminal 3 receives a search instruction from the user A. The search terminal 3 transmits the search instruction received from the user A, to the search server 10.

The search server 10 executes search processing in response to the search instruction and acquires a search result. The search server 10 transmits the acquired search result to the search terminal 3. The search terminal 3 displays the received search result on the display 3d.

FIG. 1 illustrates an example in which the user A searches for document data D. In FIG. 1, the search terminal 3 receives a search item related to the document data D from the user A as a search instruction. The search item is, for example, a file name of the document data D, some text information included in the document data D, and the like.

Furthermore, the search item may be, for example, information regarding (i.e., information on) an image object included in the document data D.

The document data is formed from a variety of objects such as text, a graph, or image data. The graph includes a table, a pie chart, a bar chart, and the like. Hereinafter, for the sake of explanation, the table may be described separately from the graph, but the table is included in the graph in one or more embodiments. The image object means image data that can be embedded in document data. The image data is data in which a pixel value is defined for each pixel in an image, and is data not including a character code. The image data includes, for example, data in a JPEG format, a GIF format, a PNG format, a TIFF format, or the like.

The information regarding the image object received as the search item is, for example, a type of content represented by the image object (a picture, text, a table, a graph, an art character, and the like), a position of the image object in the document data, color information of the image object, or the like.

For example, the search terminal 3 receives, as the search item, information regarding an image object, such as “there is an image object representing a graph in a lower part of the first page of the document data”. The search server 10 searches for document data that matches the search item from among the document data stored in the document server 20. As a result, the display 3d displays a thumbnail image T of the document data D.

<Index Information>

The search server 10 stores index information for searching for a plurality of pieces of document data stored in the document server 20. The index information is retrieval information regarding a plurality of pieces of document data for improving efficiency of the search processing of the search server 10.

The search server 10 performs addition processing and update processing of the index information. The index information includes, for each of a plurality of pieces of document data stored in the document server 20, a file name and a directory of each piece of document data, text information included in each piece of document data, information regarding an image object included in each piece of document data, or information regarding document data associated with each piece of document data.

For example, when the document data is newly stored in the document server 20, the search server 10 adds index information of the newly stored document data. Hereinafter, the processing for the search server 10 to add the index information to the newly stored document data may be simply referred to as “addition processing”.

Further, the search server 10 updates the index information for all or some of the document data stored in the document server 20 every time a predetermined period (for example, 30 minutes) elapses. Hereinafter, the processing for the search server 10 to update the index information may be simply referred to as “update processing”.

Further, hereinafter, the addition processing or the update processing of the index information may be collectively referred to as “index processing”.

The search server 10 may perform the update processing when a load of a CPU included in the search server 10 is smaller than a threshold value.

As described above, in the document search system 1, the addition processing is performed on the newly stored document data, and the update processing is periodically performed. This allows the search server 10 to perform search processing on the basis of relatively new index information.

<Association of Document Data>

Hereinafter, processing of associating document data will be described. In the document search system 1, when the search server 10 has successfully specified other document data that can be associated with document data targeted for the index processing, association processing is performed.

When an image object included in document data is similar to an object included in another document data, the search server 10 determines that the image object is associated with the another document data.

The search server 10 stores the association between the image object and the another document data as index information. This allows the search server 10 to determine whether or not the image object included in the document data is associated with another document data.

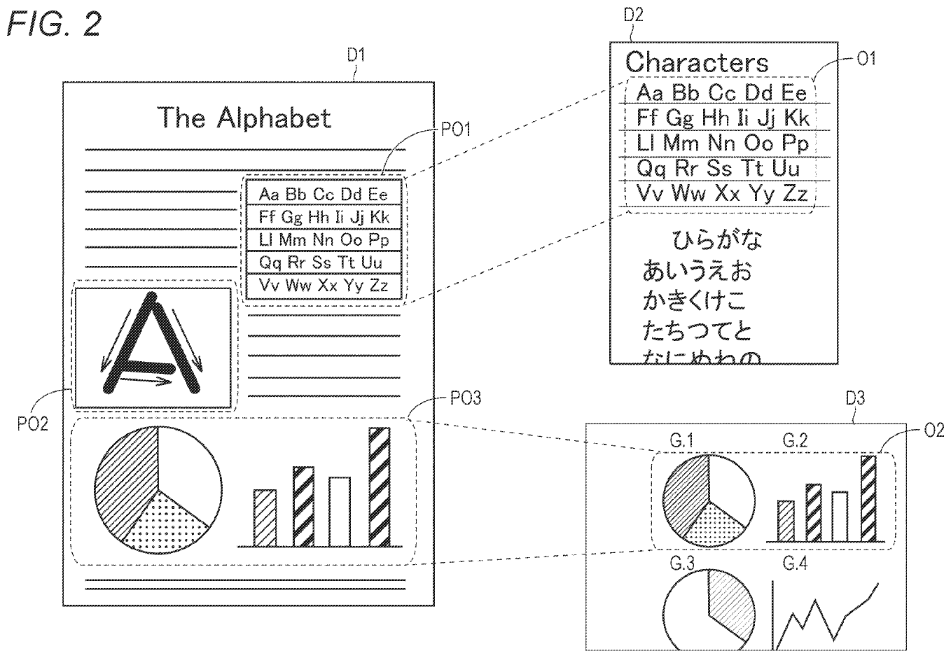

FIG. 2 is a view for explaining an image object and document data to be associated with each other. FIG. 2 illustrates document data D1, document data D2, and document data D3, which are examples of document data. The document data D1 to D3 are stored in the document server 20.

The document data D1 to D3 are files that can be edited with the document editing software. Extensions of the document data D1 and D2 illustrated in FIG. 2 are “.docx”. An extension of the document data D3 is “.xlsx”.

The document data D1 to D3 illustrated in FIG. 2 represent display screens when the document data D1 to D3 are opened by the document editing software included in the search terminal 3. For example, the document data D1 and D2 represent display screens when the document data D1 and D2 each are opened by Word. The document data D3 represents a display screen when the document data D3 is opened by Excel.

The document data D1 is document data having a content related to alphabets. The document data D1 includes image objects PO1 to PO3. The image objects PO1 to PO3 are image data embedded in the document data D1.

The image object PO1 is an image object representing alphabet characters. The image object PO2 is an image object representing a picture of how to “A”. An image object PO3 is an image object representing a graph of statistical data or the like.

The document data D1 includes an object of text information in addition to the image objects PO1 to PO3. The object of the text information is, for example, a title “The Alphabet”, a description describing the image objects PO1 to PO3, and the like.

The document data D2 is formed by an object of text information alone. The document data D3 includes an object of a graph.

The image objects PO1 to PO3 are image data. Therefore, even if the document data D1 is opened using the document editing software, the user is not able to edit a content represented by the image objects PO1 to PO3.

That is, the alphabet characters represented by the image object PO1 are displayed not as text information but as image data. Therefore, even when the document editing software is used, the alphabet characters are not editable.

As illustrated in FIG. 2, the alphabet characters represented by the image object PO1 are similar to an object O1 that is text information included in the document data D2. The object O1 is not an image object but an object of text information. Therefore, when the document data D2 is opened using the document editing software, the user can edit the alphabet characters of the object O1.

The image object PO3 is similar to an image of a graph represented by an object O2 included in the document data D3. The object O2 is not an image object but an object of a graph. Therefore, when the document data D3 is opened using the document editing software, the user can edit the graph of the object O2.

That is, in the image object PO1, image data such as a screenshot of the object O1 is embedded in the document data D1. Similarly, in the image object PO3, image data such as a screenshot of the object O2 is embedded in the document data D1.

When performing the index processing on the document data D1, the search server 10 stores the image object PO1 and the document data D2 in the index information in association with each other. Similarly, the search server 10 stores the image object PO3 and the document data D3 in the index information in association with each other.

That is, image data of screenshots of the document data D2 and D3 are embedded in the document data D1. Therefore, the document data D2 and D3 are associated with the image objects included in the document data D1.

Whereas, document data is not associated with the image object PO2. The image object PO2 is an image object representing a picture. That is, the image object PO2 is image data captured by a camera or the like or data created by an image editing software. Therefore, the image object PO2 has no original document data. In the document search system 1 of one or more embodiments, by associating image data including an object similar to an image object representing text or a graph that is not a picture, document data is associated with another document data used in creation of the document data. As a result, the document search system 1 associates associated data with an image object representing a content having a high possibility to be edited among image objects included in the document data. Therefore, the user can refer to the document data D2 when desiring to edit the alphabet characters represented by the image object PO1, and can refer to the document data D3 when desiring to edit the graph represented by the image object PO3. That is, the document search system 1 is a search system for search of document data including an image object, in which the data similar to the image object PO2 representing the picture is not associated, and the data similar to the image objects PO1 and PO3 representing the text or the graph is associated, so that deterioration in efficiency of document editing work can be inhibited even when the document editing work is performed after search.

Note that the document data D1 corresponds to “first data” in the present disclosure. The document data D2 and D3 correspond to “second data” in the present disclosure. The image object PO1 corresponds to an “image object representing text” in the present disclosure. The image object PO3 corresponds to an “image object representing a graph” in the present disclosure. The objects O1 and O2 correspond to “objects similar to image objects” in the present disclosure.

<Functional Block Diagram of Document Search System>

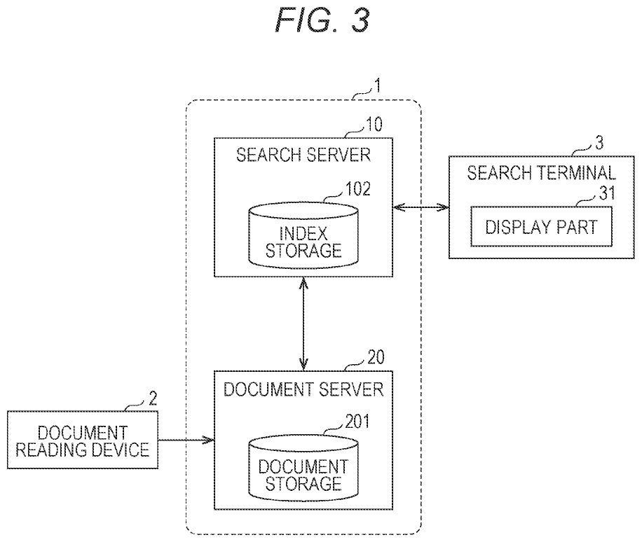

FIG. 3 is a block diagram illustrating functions of the document search system 1. The document search system 1 according to one or more embodiments includes at least the search server 10 and the document server 20.

The search server 10 includes an index storage 102. The document server 20 includes a document storage 201 for storage of a plurality of pieces of document data. The document server 20 stores, for example, a plurality of pieces of document data received from the document reading device 2 such as a scanner. Note that the document storage 201 corresponds to a “storage” in the present disclosure.

The document search system 1 may further include the search terminal 3. The search terminal 3 receives a search instruction from the user and transmits the search instruction to the search server 10. In response to the received search instruction, the search server 10 executes search processing using the index information, and transmits a search result to the search terminal 3. A display part (i.e., display) 31, which is the display 3d in FIG. 1, displays the search result received from the search server 10. The display part 31 may perform display formed of segments instead of the display 3d, or output by sound or the like in addition to display by the display 3d. Note that, in FIG. 1, the display part 31 corresponds to a “display part” in the present disclosure.

The configuration of the document search system 1 illustrated in FIG. 3 is an example, and the search server 10, the document server 20, the search terminal 3, and the document reading device 2 may be partially or entirely integrated, for example.

<Configuration of Search Server>

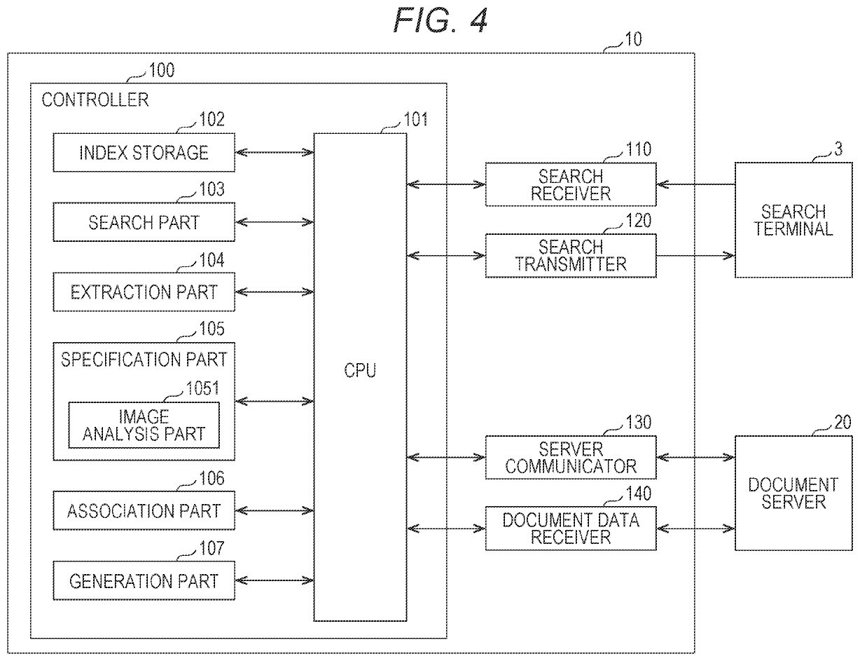

FIG. 4 is a diagram illustrating an internal configuration of the search server 10. The search server 10 includes a controller 100, a search receiver 110, a search transmitter 120, a server communicator 130, and a document data receiver 140.

The controller 100 includes a CPU 101, the index storage 102, a search part 103, an extraction part 104, a specification part 105, an association part 106, and a generation part 107.

Note that the search part 103 corresponds to a “search part” in the present disclosure. The extraction part 104 corresponds to an “extraction part” in the present disclosure. The specification part 105 corresponds to a “specification part” in the present disclosure. The association part 106 corresponds to an “association part” in the present disclosure. The generation part 107 corresponds to a “generation part” in the present disclosure. The controller 100 corresponds to a “computer” in the present disclosure.

The CPU 101 can execute instructions for realizing various functions of the search server 10. The CPU 101 includes at least one integrated circuit. The integrated circuit includes, for example, at least one CPU or FPGA, or a combination thereof.

The CPU 101 refers to a RAM (not illustrated) in order to execute instructions. The RAM is, for example, a dynamic random access memory (DRAM) or a static random access memory (SRAM).

The index storage 102 is, for example, a nonvolatile memory such as a hard disk drive (HDD), a solid state drive (SSD), an erasable programmable read only memory (EPROM), an electrically erasable programmable read only memory (EEPROM), or a flash memory.

The index storage 102 stores, for each piece of document data, data to be used for indexing a plurality of document data stored in the document server 20.

At a timing when receiving information indicating that the document server 20 newly stores document data from the server communicator 130 to be described later, the CPU 101 performs generation processing of newly generating index information for the document data in the index storage 102. Further, the CPU 101 periodically performs the update processing every time a predetermined period elapses.

The search part 103 performs search processing with, as search targets, a plurality of pieces of document data stored in the document server 20, on the basis of a search item received by the search receiver 110.

The extraction part 104 extracts document data targeted for the index processing from among a plurality of pieces of document data stored in the document server 20. Thereafter, the extraction part 104 extracts an image object included in the document data targeted for the index processing. The specification part 105 specifies document data including an object similar to the image object extracted by the extraction part 104, from among the document data stored in the document server 20.

The specification part 105 includes an image analysis part 1051. The image analysis part 1051 performs image analysis processing on an image object extracted by the extraction part 104.

The image analysis part 1051 acquire, by the image analysis processing, a type of content represented by the image object. The type of content represented by the image object is predetermined, and includes at least one of text or a graph. Moreover, the predetermined type of content represented by the image object may further include a picture, an art character, a table, or the like.

The specification part 105 specifies document data including a similar object on the basis of the image analysis processing of the image analysis part 1051.

The association part 106 associates the document data targeted for the index processing with the document data specified by the specification part 105, and stores the document data in the index storage 102.

An example in which the search server 10 performs index processing will be described with reference to FIG. 2. The type of content represented by the image object PO1 is text. The type of content represented by the image object PO2 is a picture. The type of content represented by the image object PO3 is a graph.

When the search server 10 performs the index processing on the document data D1, the extraction part 104 extracts the image objects PO1 and PO3. The extraction part 104 exclusively extracts image objects indicating information editable with the document editing software.

Therefore, image objects PO1 and PO3 that are text and a graph, which can be edited with the document editing software, are extracted. Whereas, since the picture indicated by the image object PO2 is not editable with the document editing software, the extraction part 104 does not extract the image object PO2.

The specification part 105 specifies other document data including an object similar to the image objects PO1 and PO3 extracted by the extraction part 104, from among the document data stored in the document server 20. The specification part 105 specifies the document data D2 for the image object PO1. The specification part 105 specifies the document data D3 for the image object PO3.

The association part 106 stores the document data D2 specified by the specification part 105 and the image object PO1 in the index storage 102 in association with each other.

In the search server 10, by the extraction part 104, the specification part 105, and the association part 106, the document data can be stored in the index storage 102 in association with each other.

The generation part 107 generates new data corresponding to a content represented by an image object. The new data generated by the generation part 107 is generated so as to be editable with the document editing software. The new data generated by the generation part 107 corresponds to “third data” in the present disclosure.

The search receiver 110 receives a search instruction from the user from the search terminal 3. In addition to the search instruction, the search receiver 110 can receive a command from the user via the search terminal 3. The search instruction includes a search item such as text, or a type, a color, or a position of an image object. For example, the search terminal 3 receives text information of “The Alphabet” as a search item from the user. The search part 103 searches for document data including text information of “The Alphabet” from among a plurality of pieces of document data stored in the document server 20.

Alternatively, the search terminal 3 receives, from the user, a search item that an image object representing a graph is included on the document data. The search part 103 searches for document data having an image object representing a graph from among a plurality of pieces of document data stored in the document server 20.

The search transmitter 120 displays a search result of the search part 103. That is, the search transmitter 120 provides a file name, a directory, a thumbnail image, and the like of the document data to the search terminal 3 as the search result.

The server communicator 130 communicates with the document server 20 that stores document data to be a search target.

The document data receiver 140 receives, from the document server 20, a file name, a directory, a thumbnail image, and the like of the document data as a result of the search by the search part 103.

<Processing Procedure in Search Terminal>

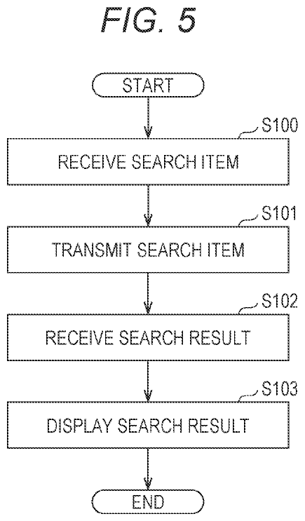

FIG. 5 is a flowchart illustrating a processing procedure in the search terminal 3. The search terminal 3 receives a search item from the user (step S100). The search terminal 3 transmits the search item to the search server 10 (step S101). The search terminal 3 receives a search result from the search server 10 (step S102). The search terminal 3 displays the received search result on the display 3d (step S103). As a result, the document search function of the document search system 1 is provided to the user.

<Association Processing Procedure of Search Server 10>

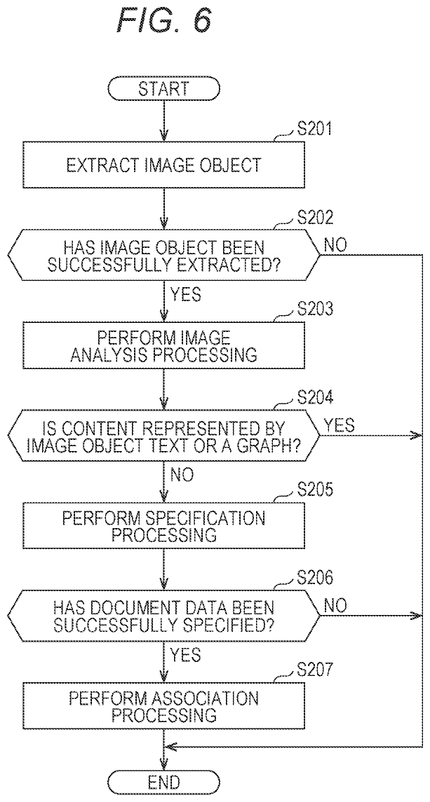

FIG. 6 is a flowchart illustrating a procedure of the association processing of the search server 10. When performing the index processing described above, the search server 10 performs the association processing for each piece of document data stored in the document server 20.

The extraction part 104 of the search server 10 extracts an image object from document data targeted for the index processing (step S201). The controller 100 of the search server 10 determines whether or not an image object has been successfully extracted from the document data targeted for the index processing (step S202). When the controller 100 of the search server 10 determines that the image object has failed to be extracted (NO in step S202), the controller 100 of the search server 10 ends the processing.

When the controller 100 of the search server 10 determines that the image object has been successfully extracted (YES in step S202), the image analysis part 1051 of the search server 10 performs the image analysis processing on the image object extracted by the extraction part 104 (step S203). The image analysis processing will be described in detail later.

The controller 100 of the search server 10 determines whether or not the content represented by the image object extracted by the extraction part 104 is text or a graph (step S204). Here, the text is text including an art character. Further, the graph includes a table, a pie chart, and a bar chart. When the content represented by the image object is text or a graph (YES in step S204), the controller 100 of the search server 10 ends the processing.

When the content represented by the image object is not text or a graph (NO in step S204), the specification part 105 of the search server 10 specifies document data including an object similar to the image object, from among the document server 20 (step S205). The controller 100 of the search server 10 determines whether or not the specification part 105 has successfully specified the document data (step S206).

When the specification part 105 has failed to specify the document data (NO in step S206), the controller 100 of the search server 10 ends the processing. When the specification part 105 has successfully specified the document data (YES in step S206), the association part 106 of the search server 10 associates the document data specified by the specification part 105 with the document data targeted for the index processing, stores information indicating the association in the index storage 102, and ends the processing.

<Display Example 1 of Search Result>

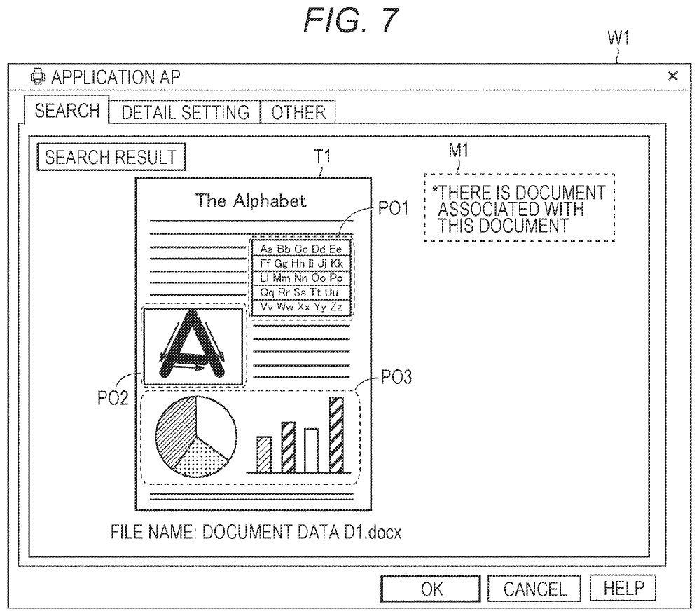

FIG. 7 is Display example 1 of a search result displayed by the search terminal 3. The search result is displayed on a window W1. The search terminal 3 displays the document data D1 as a search result. A thumbnail image T1 is a thumbnail image of the document data D1.

The search server 10 performs the association processing on the document data D1 when the index processing is performed. That is, the index storage 102 stores that the document data D2 is associated with the image object PO1 of the document data D1. Further, the index storage 102 stores that the document data D3 is associated with the image object PO3.

When transmitting the document data D1 as a search result to the search terminal 3, the search server 10 determines whether or not there is document data associated with the image object included in the document data D1.

Since the document data D2 and D3 are associated with the image objects PO1 and PO3 included in the document data D1, respectively, the search server 10 transmits, to the search terminal 3, that the document data D2 and D3 are associated.

That is, the search terminal 3 displays a message M1 together with the thumbnail image T1 as the search result. The message M1 displays to the user that there is document data associated with the document data D1. The message M1 is not limited to a mode illustrated in FIG. 7, and color tones of the image objects PO1 and PO3 in the thumbnail image T1 may be changed, for example. Alternatively, peripheries of the image objects PO1 and PO3 may be surrounded by a red frame to be displayed in an emphasized manner. Note that the message M1 corresponds to “information indicating that one or more pieces of second data are associated” in the present disclosure.

As a result, when editing the document data D1 as the search result, the document search system 1 can display to the user that document data including an object similar to an uneditable image object is stored in the document server 20.

In the document search system 1, in a case where the associated document data is the original document data when the image object is created, the content represented by the image object can be edited from the associated data. This can improve convenience of the document editing work when the user performs the document editing work after search.

Further, even in a case where the associated document data is not the original document data when the image object is created, the user can grasp that the document data that can be referred to is stored in the document server 20, when editing the document data D1.

In short, the document search system 1 displays data associated with an image object to be displayed as a search result. Whereas, in the document editing work, the document search system 1 does not display data related to data representing information that is not editable with the document editing software. Moreover, in the document search system 1, in the document editing work, data related to data representing information editable with the document editing software is exclusively displayed as related data.

If the document data D1 does not include the image objects PO1 and PO3 but includes the image object PO2 alone, the message M1 is not to be displayed. Thus, by displaying document data including an object similar to a picture that is not editable with the document editing software, it is possible to inhibit display of irrelevant data in the document editing work, and can inhibit deterioration in efficiency of the document editing work.

That is, in the document search system 1, by displaying that there is document data including an object similar to an image object representing text or a graph, it is possible to inhibit display of irrelevant data and to inhibit deterioration in efficiency of the document editing work, while improving convenience of the document editing work on the document data D1.

Note that, in the document search system 1, the data associated with the search result may not be displayed by the display part 31, and may be printed by a multifunction peripheral or the like connected via a network. Furthermore, the data associated with the search result may be transmitted to another terminal by the search server 10.

<Display Example 2 of Search Result>

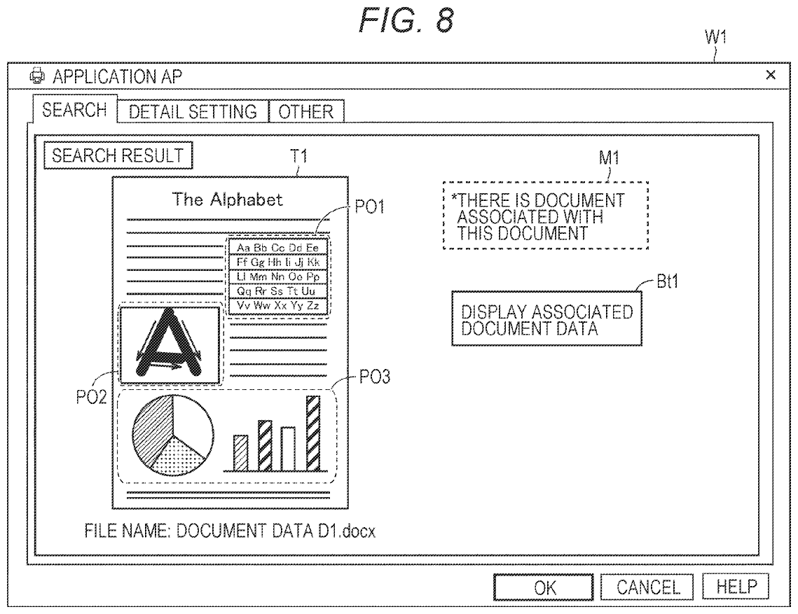

FIG. 8 is Display example 2 of a search result displayed by the search terminal 3. In the display example of FIG. 8, the description of the configuration overlapping with the display example of FIG. 7 will not be repeated.

In FIG. 8, a button Bt1 is displayed near the message M1. When the button Bt1 is selected by the user, the search terminal 3 displays information regarding at least one of the document data D2 or the document data D3. For example, the search terminal 3 displays a file name, a directory, a thumbnail image, or the like of at least one of the document data D2 or the document data D3.

As a result, the document search system 1 can provide the user with information regarding the document data D2 and D3 associated with the image objects PO1 and PO3 included in the document data D1. After displaying the search result, the document search system 1 can display the document data D2 and D3 that may be used in the document editing work, to improve convenience of the document editing work. Note that the information regarding the document data D2 and D3 displayed by selecting the button Bt1 corresponds to “information regarding (i.e., information on) one or more pieces of second data” of the present disclosure.

<Display Example 3 of Search Result>

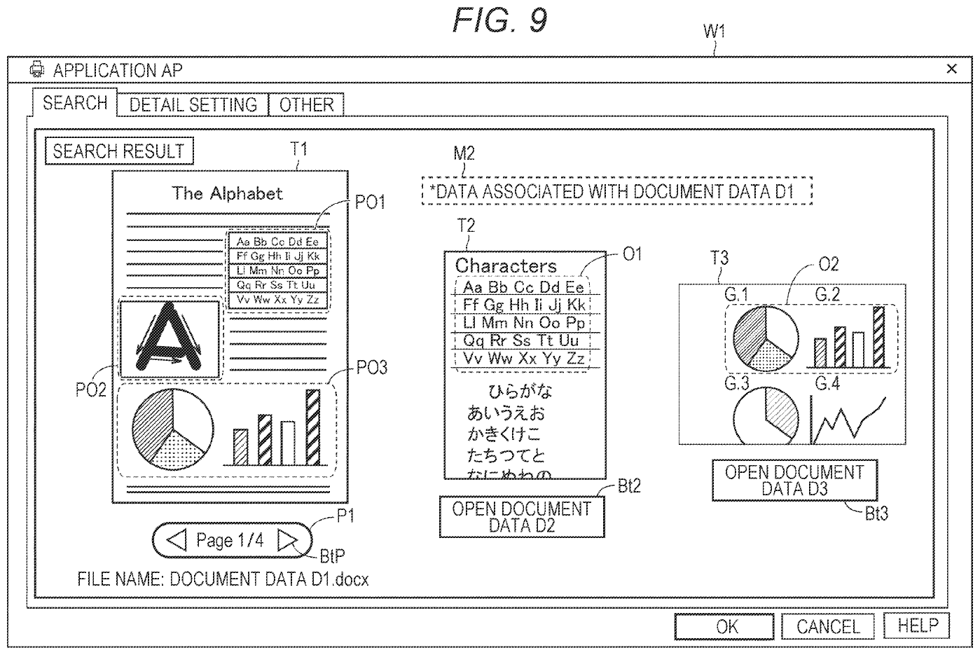

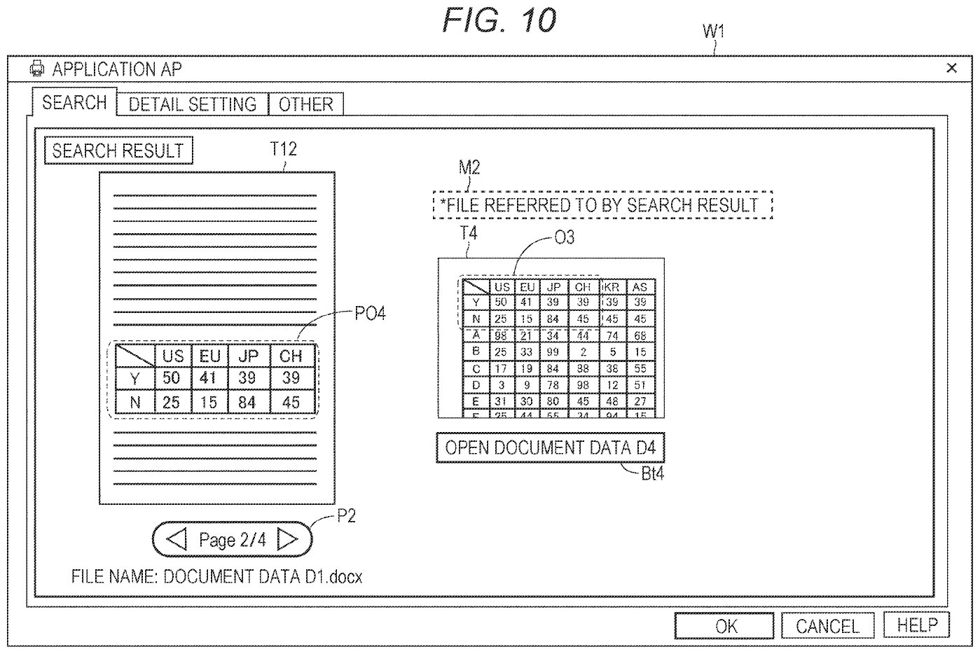

Hereinafter, Display example 3 of a search result will be described with reference to FIGS. 9 and 10. In the display examples of FIGS. 9 and 10, the description of the configuration overlapping with the display example of FIG. 7 will not be repeated.

FIG. 9 is Display example 3-1 of a search result displayed by the search terminal 3. In FIG. 9, a page display P1 is displayed near the thumbnail image T1.

The page display P1 displays a total number of pages of the document data D1 and which page of the pages included in the document data D1 is represented by the thumbnail image T1. That is, the page display P1 indicates that the document data D1 includes four pages, and indicates that the thumbnail image T1 represents the first page.

A thumbnail image T2 is a thumbnail image of the document data D2 associated with the image object PO1. When a button Bt2 is pressed by the user, the search terminal 3 opens the document data D2.

A thumbnail image T3 is a thumbnail image of the document data D3 associated with the image object PO3. When a button Bt3 is pressed by the user, the search terminal 3 opens the document data D3. A message M2 indicates that the thumbnail images T2 and T3 are thumbnail images of the associated document data.

When a button BtP included in the page display P1 is pressed, the search terminal 3 displays the display example illustrated in FIG. 10.

FIG. 10 is Display example 3-2 of a search result displayed by the search terminal 3. In FIG. 10, by the button BtP of FIG. 9 being pressed, a page of the document data D1 displayed as a thumbnail image is transmitted.

That is, a thumbnail image T12 represents the second page of the document data D1. The document data D1 includes an image object PO4 on the second page. The image object PO4 is similar to an object O3 included in document data D4. The object O3 is an object representing a table included in the document data D4. In one or more embodiments, the table is included in the graph. The image object PO4 corresponds to an “image object representing a graph” in the present disclosure.

Therefore, when performing the index processing on the document data D1, the search server 10 associates the document data D4 with the image object PO4. Accordingly, as illustrated in FIG. 10, a thumbnail image T4 of the document data D4 is displayed. When a button Bt4 is pressed by the user, the search terminal 3 opens the document data D4.

As illustrated in FIGS. 9 and 10, in the document search system 1, in addition to the thumbnail image T1 of the document data D1 displayed as the search result, a thumbnail image of the associated document data is displayed.

As a result, it is possible to easily determine whether or not the associated document data is data for which the user intends to perform the document editing work. Note that thumbnail images T2, T3, and T12 correspond to “a thumbnail image of one or more pieces of second data” in the present disclosure.

<Display Example 4 of Search Result>

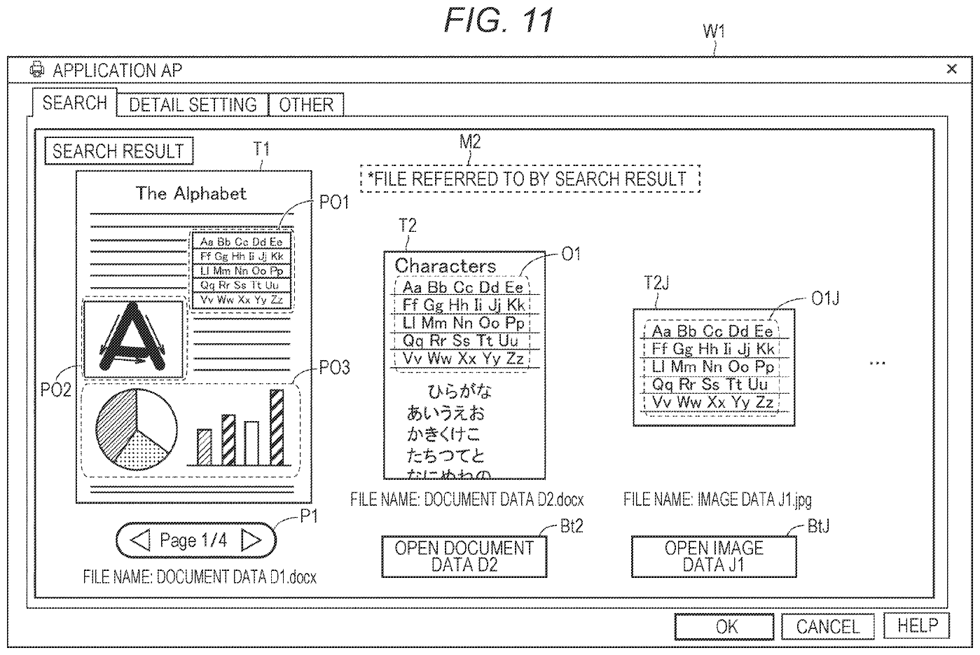

FIG. 11 is Display example 4 of a search result displayed by the search terminal 3. In the display example of FIG. 11, the description regarding the configuration overlapping with the display examples of FIGS. 7 and 9 will not be repeated.

In FIG. 11, a plurality of pieces of data are associated with the image object PO1. The image object PO1 is associated with image data J1 in addition to the document data D2. The image object PO1 is similar to an object O1J included in the image data J1. A thumbnail image T2J represents the image data J1. When a button BtJ is pressed by the user, the search terminal 3 opens the image data J1.

As illustrated in FIG. 11, the thumbnail image T2 is displayed closer to the thumbnail image T1 than a thumbnail image T2J. As a result, the document search system 1 displays the thumbnail image T2 in a more emphasized manner than the thumbnail image T2J in the window W1.

The document data D2 represented by the thumbnail image T2 can be edited with the document editing software. That is, the user can edit a content represented by the image object PO1 by editing the document data D2. Whereas, the image data J1 is not editable with the document editing software.

Therefore, the document search system 1 displays the thumbnail image T2 in a more emphasized manner than the thumbnail image T2J. In the document search system 1, as a method of emphasizing the thumbnail image T2, a periphery of the thumbnail image T2 may be surrounded by a color frame. Alternatively, the document search system 1 may display the thumbnail image T2 larger than the thumbnail image T2J.

Moreover, even when a plurality of pieces of data are associated with the image object PO2, the document search system 1 may hide data in a case where the associated data is data that is not editable with the document editing software. That is, the search terminal 3 hides the thumbnail image T2J.

This allows the document search system 1 to display the thumbnail image T2 of the document data D2 associated with the image object PO1 representing alphabet characters that are text editable with the document editing software, among the image objects PO1 to PO3 included in the document data D1 displayed as a search result.

Moreover, the document search system 1 may determine whether or not the object O1 included in the document data D2 is editable. This is because the user is not able to edit the alphabets represented by the image object PO1 in a case where the object O1 is image data, even if the document data D2 itself can be edited with the document editing software.

As a result, the document search system 1 can more reliably display, to the user, data including the content represented by the image object PO1 that can be edited with the document editing software.

<Image Analysis Processing and Specification Processing>

The image analysis processing and specification processing will be described below. The specification processing is processing of specifying data including an object similar to a content represented by an image object. The image analysis part 1051 of the specification part 105 of the search server 10 performs the image analysis processing on an image object extracted by the extraction part 104.

In one or more embodiments, by the image analysis processing, the specification part 105 determines whether a type of content represented by the image object is text including an art character or a graph including a table.

Moreover, the specification part 105 changes a type of the specification processing on the basis of the type of content represented by the image object. Hereinafter, the specification processing for specifying similar data for each type of content represented by an image object will be described.

[Image Object Representing Text]

The image analysis part 1051 performs optical character recognition (OCR) processing on an image object. The image analysis part 1051 determines whether or not a character has been successfully recognized from the image object, by OCR processing. In a case where the character has been successfully recognized, the image analysis part 1051 calculates a ratio of the recognized character occupying a region of the image object.

In a case where the ratio of the recognized character occupying the region of the image object is equal to or greater than a predetermined ratio, the image analysis part 1051 determines that the type of content represented by the image object is text. The predetermined ratio is, for example, 80% or more.

The specification part 105 performs the specification processing of specifying data including an object similar to an image object from among data stored in the document server 20. In a case where the image analysis part 1051 determines that the type of content represented by the image object is text, the specification part 105 performs the specification processing by using the character recognized by the OCR processing.

That is, the specification part 105 specifies document data including the character recognized by OCR processing from among a plurality of pieces of document data, by using the index information. This allows specification of document data including an object similar to an image object representing text. Hereinafter, in a case where the type of content represented by the image object is text, the specification processing performed by the specification part 105 is referred to as “specification processing 1”. “Specification processing 1” is processing of determining whether or not being similar to each other on the basis of a matching degree between text indicated by an image object and text information included in data. Further, when the type of content represented by the image object is text, the specification processing performed by the specification part 105 corresponds to “text search processing” of the present disclosure.

[About Art Character]

The art character is included in the text. The art character means a decorated text. Therefore, there may be a case where the image analysis part 1051 is not able to recognize the art character even if the OCR processing is performed on an image object.

In a case where a character is not able to be recognized after the OCR processing is performed on the image object, the image analysis part 1051 reduces a resolution of the image object by a predetermined value set in advance. After the reduction, the image analysis part 1051 performs the OCR processing on the image object again. When the character is not able to be recognized, the resolution of the image object is further reduced by a predetermined value.

The image analysis part 1051 repeats reduction in resolution and the OCR processing, and determines that the image object represents an art character in the text when a character is recognized at a certain point of time.

The specification part 105 specifies document data including the character recognized by OCR processing from among a plurality of pieces of document data, by using the index information. This allows specification of document data including an object similar to an image object representing text.

Hereinafter, in a case where the type of content represented by the image object is the art character, the specification processing performed by the specification part 105 is referred to as “specification processing 4”.

[Image Object Representing Graph]

The image analysis part 1051 analyzes pixel values included in an image object. By analyzing the pixel values, the image analysis part 1051 determines whether or not the image object includes a shape similar to a pie chart or a bar chart.

Furthermore, in a case where the image object includes a shape similar to a pie chart or a bar chart, the image analysis part 1051 determines that the content represented by the image object is a graph. Further, when it is determined that a straight line having a shape similar to that of a line graph is included, the image analysis part 1051 determines that the content represented by the image object is a graph. The image analysis part 1051 determines which type of the graph such as a pie chart, a bar chart, or a line graph the content represented by the image object is.

Furthermore, the image analysis part 1051 recognizes a character included in the graph represented by the image object, by performing the OCR processing on the image object.

On the basis of the type of graph determined by the image analysis part 1051, the specification part 105 specifies document data including the same type of graph and including the same character as the character recognized by the OCR processing.

Hereinafter, in a case where the type of content represented by the image object is a graph, the specification processing performed by the specification part 105 is referred to as “specification processing 3”. “Specification processing 3” is processing of determining whether the image object represents a graph, by the image analysis processing.

[About Table]

A table is included in a graph. The image analysis part 1051 analyzes pixel values included in an image object. By analyzing the pixel values, the image analysis part 1051 can determine whether or not a straight line is included in the image object. In addition, the image analysis part 1051 determines whether or not a plurality of straight lines formed in a grid shape are included in the image object.

In a case where it is determined that a plurality of straight lines in a grid shape are included, the image analysis part 1051 performs the OCR processing on the image object. The image analysis part 1051 determines whether or not a character or a word recognized by the OCR processing is arranged in a grid formed by straight lines. In a case where a character or a word is arranged in the grid, the image analysis part 1051 determines that the image object represents a table in the graph.

When it is determined that the image object represents the table in the graph, the specification part 105 determines whether document data includes an object of a table, and a character inputted in the table matches a character recognized by the OCR processing.

In a case where a configuration of the table and a matching ratio of the characters exceed a predetermined threshold value, the specification part 105 specifies as data including an object similar to the image object indicating the table in the graph. Hereinafter, in a case where the type of content represented by the image object is a table, the specification processing performed by the specification part 105 is referred to as “specification processing 2”. “Specification processing 2” is processing of determining whether or not a table is included in a graph in a content represented by an image object, by the image analysis processing. The table is not limited to a table in a grid shape, and may be a table having another shape.

[Image Object Representing Picture]

As a result of the analysis of pixel values, the image analysis part 1051 determines, for all the pixels, whether or not pixel values between adjacent pixels have changed. In a case where a ratio of a region in which pixels having the same pixel value are adjacent to a region of an image object is less than a predetermined ratio, the image analysis part 1051 determines that a content represented by the image object is a picture. The predetermined ratio is, for example, 70%. That is, since gradation of a picture taken by a camera changes drastically, a region having the same pixel value between adjacent pixels is smaller than an image representing text, a graph, or the like created by the document editing software.

When it is determined that the content represented by the image object is a picture, the specification part 105 does not perform the specification processing.

As described above, the specification part 105 performs the specification processing in accordance with the type of content represented by the image object determined by the image analysis part 1051. By performing the specification processing in accordance with each type of content represented by the image object, efficiency and a speed of the specification processing are improved.

In a case where the image analysis part 1051 is not able to determine which type the content represented by the image object is, the image analysis part 1051 analyzes all the pixel values included in the image object. The specification part 105 specifies an image object that matches the pixel value analyzed by the image analysis part 1051 by a predetermined ratio or more. The processing of comparing all the pixel values of the image object corresponds to “image search processing” of the present disclosure.

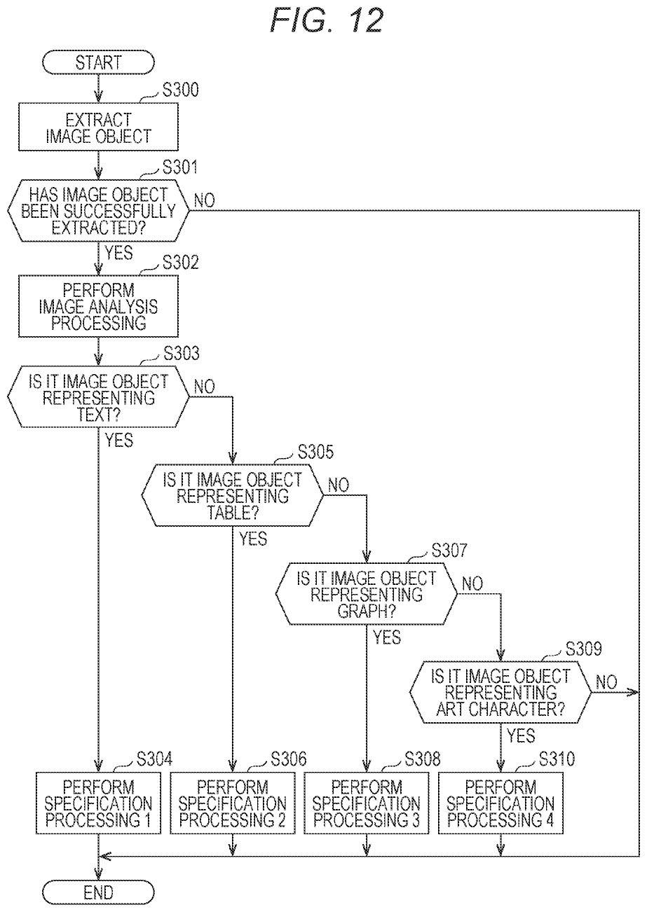

FIG. 12 is a flowchart illustrating a procedure of the specification processing. The extraction part 104 of the search server 10 extracts an image object (step S300). The search server 10 determines whether or not the extraction part 104 has successfully extracted the image object (step S301). When the image object has failed to be extracted (NO in step S301), the search server 10 ends the processing.

When the image object has been successfully extracted (YES in step S301), the image analysis part 1051 performs the image analysis processing on the extracted image object (step S302).

The specification part 105 determines whether or not the type of content represented by the image object is text (step S303). In a case where it is determined as text (YES in step S303), the specification part 105 performs specification processing 1 (step S304).

When it is determined that the content is not text (NO in step S304), the specification part 105 determines whether or not the type of content represented by the image object is a table (step S305). In a case where it is determined as a table (YES in step S305), the specification part 105 performs specification processing 2 (step S306).

When it is determined that the content is not table (NO in step S305), the specification part 105 determines whether or not the type of content represented by the image object is a graph (step S307). In a case where it is determined as graph (YES in step S307), the specification part 105 performs specification processing 3 (step S308).

When it is determined that the content is not graph (NO in step S307), the specification part 105 determines whether or not the type of content represented by the image object is an art character (step S309). In a case where it is determined as an art character (YES in step S309), the specification part 105 performs specification processing 4 (step S310).

When it is determined as not an art character (NO in step S309), the specification part 105 determines that the type of content represented by the image object is a picture, and ends the processing without performing the specification processing.

<Display of Image Object in Emphasized Manner>

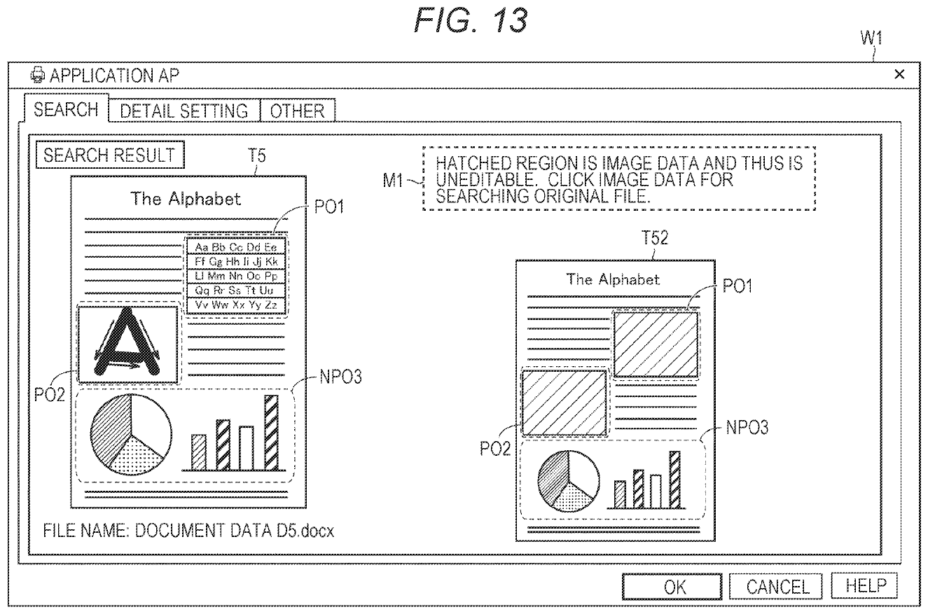

FIG. 13 is a view illustrating an example of displaying an image object in an emphasized manner. The search terminal 3 displays document data D5 as a search result. A thumbnail image T5 is a thumbnail image of the document data D5.

The document data D5 is different from the document data D1 in that an object NPO3 is not an image object. That is, the object NPO3 is an object of a graph, and is an object that can be edited by opening the document data D5 with the document editing software. The search terminal 3 displays a thumbnail image T52 in addition to the thumbnail image T5. The thumbnail image T52 is an image corresponding to the thumbnail image T5, and indicates which region of the document data D5 is the image object.

The image objects PO1 and PO2 are displayed in an emphasized manner by hatching in the thumbnail image T52.

This enables the search terminal 3 to allow the user to easily grasp which region of the thumbnail image T5 can be edited with the document editing software. The region corresponding to the object NPO3 is not hatched because the object NPO3 is an object that is not an image object and is editable with the document editing software.

Accordingly, in the document search system 1, when the document data D5 is opened by the document editing software, the user can grasp with the thumbnail image T52 that the object NPO3 is editable while the alphabet characters represented by the image object PO1 are not editable.

The search terminal 3 can receive that the user has selected the image object PO1 or the image object PO2. After the reception, the search terminal 3 transmits which image object has been selected, to the search server 10.

The search server 10 performs the update processing of index information on the received image object. In a case where the selected image object and the document data are newly associated after the update processing, the search server 10 displays the newly associated document data on the search terminal 3.

As a result, in the document search system 1, even if the image object that has not been subjected to the update processing is displayed as a search result, the index processing can be performed in real time, and more accurate information can be displayed.

A button BtN is a button that causes the generation part 107 of the search server 10 to generate editable data.

<Generation of Editable Data>

The generation part 107 of the search server 10 generates, in response to an instruction from the user, data that corresponds to a content represented by an image object and can be edited with the document editing software. For example, in FIG. 13, there may be a case where the specification part 105 is unable to specify document data associated with the image objects PO1 and PO2.

If the data associated with the image object is not able to be specified, the user is not able to edit a content represented by the image object with the document editing software.

Therefore, the search server 10 analyzes the image object by the image analysis processing, and generates data that can be edited with the document editing software.

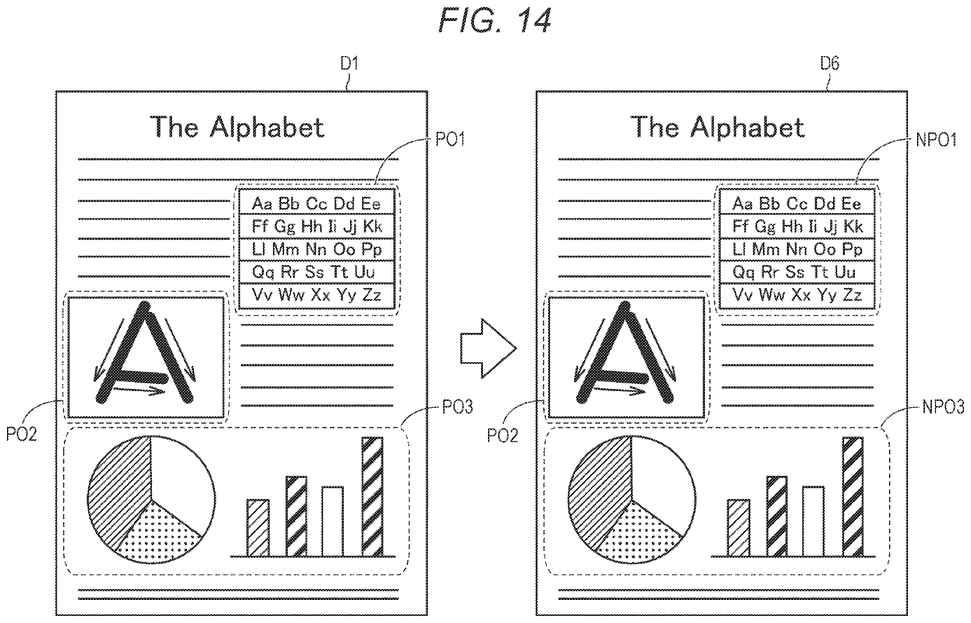

FIG. 14 is a view illustrating generation of editable data corresponding to a content represented by an image object. Upon receiving an instruction for generating editable data from the user via the button BtN in FIG. 13, the search server 10 causes the generation part 107 to generate editable data corresponding to an image object included in document data.

The generation part 107 acquires all the pixel values included in the image object by using the image analysis processing similarly to the image analysis part 1051, and acquires a type of content represented by the image object. The generation part 107 generates editable data in accordance with a result of the image analysis processing and the type of content represented by the image object.

For example, the image object PO1 is an image object representing text information. The generation part 107 performs the OCR processing on the image object PO1. The generation part 107 recognizes alphabets including “Aa to Zz”. The generation part 107 generates text information of character codes “Aa to Zz” as an object NPO1. The generation part 107 generates document data D6 including the object NPO1.

The image object PO3 is an image object representing a graph. The generation part 107 performs the image analysis processing on the image object PO3. The generation part 107 acquires that the type of content represented by the image object PO3 is a graph. The generation part 107 acquires a shape of the graph from pixel values of the image object PO3.

This allows the generation part 107 to generate the document data D6 including the object NPO3 of a pie chart and a bar chart that are editable with the document editing software. The generated objects NPO1 and NPO3 are provided so as to be usable by the user for document editing work. The generation part 107 may generate editable data for both the image objects PO1 and PO3, or may allow the user to select which image object is to be generated after the button BtN is pressed. Alternatively, by the image object PO1 or PO3 being selected, the generation part 107 may generate editable data of the selected image object without displaying the button BtN.

In a case where the generation part 107 is not able to generate the editable data even by using the image analysis processing or the OCR processing, the search terminal 3 displays to the user that the generation has been failed.

FIG. 13 illustrates an example in which the generation part 107 generates editable data by the button BtN being pressed, in the document search system 1.

When the generation part 107 has failed to generate the editable data of the image object, the specification part 105 may perform the specification processing. That is, the generation part 107 is prioritized over the specification processing of the specification part 105. As a result, in a case where the object generated by the generation part 107 is an object that can be relatively easily generated, such as text information, the specification part 105 can omit the processing of specifying from among a plurality of data. Using the object generated by the generation part 107, the user can perform document editing work on the content represented by the image object.

In a case where the specification part 105 has failed to specify the data related to the image object at the time of performing the index processing, the search server 10 may cause the generation part 107 to generate editable data for the image object. As a result, the document search system 1 can generate document editable data even for the image object for which the specification part 105 has failed to specify the data at the time of the index processing. The user can perform document editing work by using the document editable data generated by the generation part 107.

### SUMMARY

The document search system 1 according to one or more embodiments includes: the document storage 201 included in the document server 20 that stores a plurality of pieces of data; the extraction part 104 that extracts the document data D1 including the image objects PO1 and PO3 from among the plurality of pieces of data, in which the image objects PO1 and PO3 represent text or a graph; the specification part 105 that specifies the document data D2 and D3 including the objects O1 and O2 similar to the image objects PO1 and PO3 from among the plurality of pieces of data; and the association part 106 for association of each of the image objects PO1 and PO3 included in the document data D1 with the document data D2 and D3.

As a result, in the document search system 1, deterioration in efficiency of document editing work can be inhibited even when the document editing work is performed after search.

Further, there are further provided the search part 103 that searches for data in response to a search request of the user from among the plurality of data, and the display part 31 that displays the data searched by the search part 103 as a search result. When displaying the document data D1 as a search result, the display part 31 further displays information regarding the document data D2 and D3 associated with the image objects PO1 and PO3 included in the document data D1.

As a result, in a case where the document data D1 is displayed as a search result, the document search system 1 can display data associated with the content represented by the image object included in the document data D1.

Moreover, the information regarding the document data D2 and D3 includes information indicating that the document data D2 and D3 are associated with the image objects PO1 and PO3 included in the document data D1.

As a result, in the document search system 1, it is possible to display to the user that the data is associated with the document data D1 displayed as the search result.

Furthermore, the information regarding the document data D2 and D3 includes thumbnail images of the document data D2 and D3. This allows the document search system 1 to display the thumbnail images of the associated data.

Moreover, in a case where one piece of document data among the associated document data is not editable with the document editing software, the display part 31 hides information regarding the one piece of document data. As a result, even when document data that is not editable with the document editing software is associated, it is possible to inhibit unnecessary display to the user.

Further, in a case where an object included in one piece of document data of the associated data is not editable with the document editing software, the display part 31 hides information regarding the one piece of document data. As a result, even when document data including an object that is not editable with the document editing software is associated, it is possible to inhibit unnecessary display to the user.

Moreover, in a case where the document data D2 and the image data J1 are associated with the image object PO1 included in the document data D1, the display part 31 displays information regarding the document data D2 in a more emphasized manner than information regarding the image data J1 different from the document data D2, among the document data D2 and the image data J1. The image data J1 is not editable with the document editing software. The document data D2 can be edited with the document editing software.

As a result, among the associated data, the document data D2 editable with the document editing software can be displayed in an emphasized manner.

Furthermore, in a case where the document data D2 and the image data J1 are associated with the image object PO1 included in the document data D1, the display part 31 displays information regarding the document data D2 in a more emphasized manner than information regarding the image data J1 different from the document data D2, among the document data D2 and the image data J1.

The image data J1 does not include an object editable with the document editing software. The document data D2 includes an object editable with the document editing software. As a result, among the associated data, the document data D2 including the object editable with the document editing software can be displayed in an emphasized manner.

Moreover, the specification part 105 performs the specification processing of specifying the document data D2 and D3 in any of a plurality of types of specification processing 1 to 4 defined in advance. The plurality of types of specification processing 1 to 4 for performing the specification processing is changed on the basis of a type of content represented by the image objects PO1 and PO3. This makes it possible to perform appropriate specification processing in accordance with the type of content represented by the image objects PO1 and PO3, and to omit the image analysis processing of comparing all pixel values included in the image object.

Further, the type of content represented by the image objects PO1 and PO3 includes at least one of text or a graph.

Moreover, the plurality of types of specification processing 1 to 4 include at least one of the image search processing or the text search processing.

In addition, the display part 31 displays the image object PO1 included in the document data D1 displayed as a search result in an emphasized manner. This allows the document search system 1 to display an image object and other objects in a distinguished manner.

There is further provided the search receiver 110 that receives an image object selected by the user from among the image objects PO1 and PO3 displayed by the display part 31. The specification part 105 specifies document data including an object similar to the image object received by the search receiver 110, from among a plurality of pieces of data.

Furthermore, there is further provided the generation part 107 for generation of the document data D6 that is editable data, on the basis of the document data D1. The document data D6 includes the objects NPO1 and NPO3 similar to the image objects PO1 and PO3 included in the document data D1. The objects NPO1 and NPO3 are data that can be edited with the document editing software.

This allows the document search system 1 to generate an editable object with document data similar to the content represented by the image object.

Moreover, the generation part 107 generates the document data D6 when the specification part 105 has failed to specify the document data D2 and D3 similar to the image objects PO1 and PO3.

Therefore, the document data including the editable object can be newly generated for the image object that has failed to be specified by the specification part 105.

In addition, in a case where the generation part 107 has failed to generate the document data D6 on the basis of the image objects PO1 and PO3, the specification part 105 performs the specification processing of specifying the document data D2 and D3.

As a result, in the document search system 1, even when the generation part 107 fails in generation, the specification part 105 may be able to specify data including an object similar to the image object.

Moreover, a document search method according to one or more embodiments is a document search method in a document search system that stores a plurality of pieces of data. The document search method includes: extracting document data D1 including the image objects PO1 and PO3 from among a plurality of pieces of data, in which the image objects PO1 and PO3 represent text or a graph; specifying document data D2 and D3 respectively including the objects O1 and O2 similar to the image objects PO1 and PO3 from among a plurality of pieces of data; and associating the image objects PO1 and PO3 included in the document data D1 with the document data D2 and D3.

As a result, in the document search method, deterioration in efficiency of document editing work can be inhibited even when the document editing work is performed after search.

Further, instructions executed by the controller 100 capable of operating a plurality of pieces of data causes the controller 100 to execute: extracting document data D1 including the image objects PO1 and PO3 from among a plurality of pieces of data, in which the image objects PO1 and PO3 represents text or a graph; specifying document data D2 and D3 including objects O1 and O3 similar to the image objects PO1 and PO3 from among a plurality of pieces of data; and associating the image objects PO1 and PO3 included in the document data D1 with the document data D2 and D3.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A document search system comprising:
a hardware processor that:
stores a plurality of pieces of data;
extracts first data including an image object from among the plurality of pieces of data, the image object representing text or a graph;
specifies, from among the plurality of pieces of data, one or more pieces of second data including an object having a degree of similarity equal to or larger than a threshold with respect to the image object; and
associates the image object included in the first data with the one or more pieces of second data.

2. The document search system according to claim 1, further comprising:
a display that displays data searched by the hardware processor as a search result, wherein
the hardware processor searches for data from among the plurality of data in response to a search request, and
when displaying the first data as the search result, the display further displays information on the one or more pieces of second data associated with the image object included in the first data.

3. The document search system according to claim 2, wherein
the information on the one or more pieces of second data includes information indicating that the one or more pieces of second data are associated with the image object included in the first data.

4. The document search system according to claim 2, wherein
the information on the one or more pieces of second data includes a thumbnail image of the one or more pieces of second data.

5. The document search system according to claim 2, wherein
in a case where one piece of second data among the one or more pieces of second data is not editable with document editing software, the display hides information on the one piece of second data.

6. The document search system according to claim 2, wherein
in a case where the object included in one piece of second data among the one or more pieces of second data is not editable with document editing software, the display hides information on the one piece of second data.

7. The document search system according to claim 2, wherein
in a case where a plurality of pieces of second data are associated with the image object included in the first data, the display displays information on one piece of second data editable with document editing software in a more emphasized manner than information on the remaining second data that is not editable with the document editing software among the plurality of pieces of second data.

8. The document search system according to claim 2, wherein
in a case where a plurality of pieces of second data are associated with the image object included in the first data, the display displays information on one piece of second data including the object editable with document editing software in a more emphasized manner than information on the remaining second data that does not include the object editable with the document editing software among the plurality of pieces of second data.

9. The document search system according to claim 2, wherein
the hardware processor
specifies the one or more pieces of second data by at least one of a plurality of types of processing defined in advance, and
changes the at least one of the plurality of types of processing based on a type of content represented by the image object.

10. The document search system according to claim 9, wherein
the type of content represented by the image object includes at least one of text and a graph.

11. The document search system according to claim 9, wherein
the plurality of types of processing includes at least one of image search processing or text search processing.

12. The document search system according to claim 2, wherein
the display displays the image object included in the first data as the search result in an emphasized manner.

13. The document search system according to claim 2, further comprising:
a receiver that receives the image object selected from among the image objects displayed by the display, wherein
the hardware processor specifies, from among the plurality of pieces of data, the one or more pieces of second data including an object having the degree of similarity with respect to the image object received by the receiver.

14. The document search system according to claim 1, wherein
the hardware processor generates third data based on the first data,
the third data includes an object that is data editable with document editing software and that has a degree of similarity equal to or larger than a threshold with respect to the image object included in the first data.

15. The document search system according to claim 14, wherein
the hardware processor generates the third data when failing to specify the one or more pieces of second data having the degree of similarity with respect to the image object.

16. The document search system according to claim 14, wherein
the hardware processor specifies the one or more pieces of second data when failing to generate the third data based on the image object.

17. A document search method in a document search system that stores a plurality of pieces of data, the method comprising:
extracting first data including an image object from among the plurality of pieces of data, the image object representing text or a graph;
specifying, from among the plurality of pieces of data, one or more pieces of second data including an object having a degree of similarity equal to or larger than a threshold with respect to the image object; and
associating the image object included in the first data with the one or more pieces of second data.

18. A non-transitory recording medium storing instructions executed by a hardware processor operating a plurality of pieces of data, the instructions causing the hardware processor to execute:
extracting first data including an image object from among the plurality of pieces of data, the image object representing text or a graph;
specifying, from among the plurality of pieces of data, one or more pieces of second data including an object having a degree of similarity equal to or larger than a threshold with respect to the image object; and
associating the image object included in the first data with the one or more pieces of second data.
